(19) United States
(12) Patent Application Publication
(10) Pub. No.: US 2025/0192886 A1
(43) Pub. Date: Jun. 12, 2025

(54) SEAT EQUIPPED WITH A DATA-COMMUNICATION MODULE USING LI-FI TECHNOLOGY

(71) Applicant: LATELEC, TOULOUSE (FR)

(72) Inventor: Alexandre BACOU, SAINT PORQUIER (FR)

(21) Appl. No.: 18/844,962

(22) PCT Filed: Mar. 9, 2023
(86) PCT No.: PCT/EP2023/056064

§ 371 Date: Sep. 8, 2024

(30) Foreign Application Priority Data
Mar. 17, 2022 (FR) 2202351

(51) Int. Cl. H04B 10/114; B64D 11/00; B64D 11/06; H04B 10/40

(52) U.S. Cl. CPC H04B 10/1149; B64D 11/064; H04B 10/40; B64D 11/0015

(57) ABSTRACT

A seat having a backrest with adjustable inclination. An angle of inclination is within a predefined inclination range. The seat includes a Li-Fi module, positioned at an upper portion of the backrest. The Li-Fi module communicates with an associated Li-Fi device. The Li-Fi module includes at least two light sources and at least one photoreceiver. Each light source is arranged on the backrest of the seat and respectively associated with a sub-range of the inclination range of the backrest of the seat. The Li-Fi module is positioned on the backrest so that, depending on the angle of inclination of the backrest, the light source associated with the sub-range in which the angle of inclination of the backrest lies is configured to direct its emitting beam onto the Li-Fi device.

### TECHNICAL FIELD OF THE INVENTION

The invention relates to a seat equipped with a data communication module using Li-Fi technology.

The invention is particularly intended for an application in the aeronautics field, for aircraft seats with inclinable backrests, in particular seats located in economy class.

### PRIOR ART

There is a growing need expressed by aircraft passengers to be able to access the aircraft communications network with their own portable electronic equipment (computer, telephone, tablet, etc.). This need is mainly expressed by passengers on short-haul aircraft because they are not equipped with on-board entertainment systems (known as IFE systems, acronym for In Flight Entertainment).

To meet this need, a gradual deployment of various wireless communication technologies in aircraft is now being witnessed.

Some aircraft cabins are already equipped with Wi-Fi technology (acronym for Wireless Fidelity) to provide an internet connection to passengers' portable electronic equipment. However, Wi-Fi has many disadvantages. Among others, the use of Wi-Fi may cause interference with other devices present in the aircraft, or may raise public health questions regarding the risks associated with prolonged exposure to electromagnetic radiation.

Another emerging technology is Li-Fi technology (acronym for Light Fidelity). Li-Fi technology is a wireless communication technology based on the use of light in the visible range (wavelength comprised between 400 nm and 780 nm) or the infrared range (wavelength comprised between 780 nm and 2 μm) as a vector of information. The principle of Li-Fi is based on the coding and sending of data via amplitude, frequency or phase modulation of a light source, according to a standardised protocol. Li-Fi technology advantageously allows to overcome the constraints related to data security, the electromagnetic pollution encountered with Wi-Fi and its health problems.

Concretely, in an aircraft cabin, for a seat, a first data communication device using Li-Fi technology is housed in a ceiling of the cabin and includes a light source and a photoreceiver. A second data communication device using Li-Fi technology is housed in the seat, generally the backrest, and also includes a light source and a photoreceiver. The second data communication device using Li-Fi technology is disposed in the emission cone of the light source of the first device, allowing the establishment of communication between the first data device using Li-Fi technology and the second data device using Li-Fi technology. Respectively, the first data communication device using Li-Fi technology is disposed in the emission cone of the light source of the second device, allowing the establishment of communication between the second data device using Li-Fi technology and the first data device using Li-Fi technology.

Although the distance between the seat and the cabin ceiling is not large, generally comprised between 500 mm and 1500 mm, the divergence angle of the emission cone of the light source of the second data device using Li-Fi technology is defined so that the spot covers the first data communication device using Li-Fi technology.

However, in economy class, the backrests of the seats can be inclined, with an angle of inclination that can sometimes reach up to 30°. To guarantee the transmission of data between the seat and the ceiling, this strong inclination of the seat requires the choice, for the light source of the second data device using Li-Fi technology, of a light source with a divergence angle of the emission cone that is very significant, of the order of 60°, and a spot with a diameter greater than or equal to 1500 mm depending on the distance between the seat and the ceiling. Such a constraint does not guarantee the flow rate because the optical power received by the photoreceiver of the first data communication device using Li-Fi technology is too low. In addition, the use of a light source with on the one hand an angle of divergence of the emission cone sufficient to cover the first data communication device regardless of the inclination of the backrest and on the other hand with a sufficient optical power received by the photoreceiver of the first data communication device using Li-Fi technology to guarantee the flow rate necessary for data transmission is consuming in electrical power, which can lead to thermal heating of the light source and in consequently reduce the lifespan of the light source.

### Presentation of the Invention

The present invention aims at overcoming the aforementioned drawbacks.

In particular, the present invention allows to guarantee data communication from a seat, regardless of the inclination of the backrest of said seat.

For this purpose, the present invention proposes a seat comprising a backrest adjustable in inclination, with an angle of inclination comprised within a predefined inclination range, said seat including a data communication module using Li-Fi technology, called Li-Fi module, positioned at an upper portion of the backrest, said Li-Fi module being intended to communicate with an associated data communication device using Li-Fi technology, called Li-Fi device. The Li-Fi device is disposed outside the seat. The Li-Fi module includes:
at least two light sources, each light source being configured to emit an emitting beam,
at least one photoreceiver.

The light sources may preferably be light-emitting diodes or laser diodes. The at least one photoreceiver may preferably be a photodiode.

The at least two light sources are aligned, disposed parallel to a median longitudinal plane of the seat. Each light source of the Li-Fi module is arranged on the backrest of the seat so as to be respectively associated with a sub-range of the inclination range of the backrest of the seat. The Li-Fi module (100) is configured such that, depending on the angle of inclination of the backrest, at least the light source (110) associated with the sub-range in which the angle of inclination of the backrest lies (222) is active. The Li-Fi module is positioned on the backrest of the seat so that, depending on the angle of inclination of the backrest, the light source associated with the sub-range in which the angle of inclination of the backrest lies is configured to direct its emitting beam onto the associated Li-Fi device.

A seat equipped with such a Li-Fi module advantageously allows, regardless of the angle of inclination of the backrest, to guarantee the transmission of data between the seat and the Li-Fi device, and therefore to guarantee the flow rate, even when the backrest is inclined.

The invention allows to optimize the maximum divergence angle of the light beam of the light sources of the Li-Fi module, because it is no longer necessary to use light sources having a light beam with a divergence angle sufficient to cover the Li-Fi device, regardless of the inclination of the backrest.

In particular embodiments, the invention further meets the following features, implemented separately or in each of their technically effective combinations.

In particular embodiments of the invention, the Li-Fi module is configured so that all the light sources are active at the same time.

In particular embodiments of the invention, the Li-Fi module includes:
a device for detecting the position of the backrest of the seat configured to determine the angle of inclination of the backrest of the seat,
a controller configured to control the at least two light sources according to the angle of inclination of the backrest of the seat.

In particular embodiments of the invention, the controller being configured so that, depending on the angle of inclination of the backrest, only the light source associated with the sub-range of inclination of the backrest of the seat in which the angle of inclination of the backrest lies is activated. Other light sources are inactive or deactivated. Thus, the electrical consumption of the light sources is limited by activating only the light source which directs its emitting beam onto the associated Li-Fi device.

In particular exemplary embodiments of the invention, the device for detecting the position of the backrest of the seat is an inclinometer or a time-of-flight distance sensor.

In particular embodiments of the invention, the at least two light sources are each soldered respectively on a rigid printed circuit board, the rigid printed circuit boards being connected together by a flexible printed circuit board. By using flexible printed circuit boards, it is possible to adapt the positioning of the at least two light sources and the at least one photoreceiver to the shape of the upper portion of the backrest.

In particular embodiments of the invention, the Li-Fi module includes a casing for protecting the at least two light sources, the at least one photoreceiver, and where appropriate the device for detecting the position of the backrest of the seat. Such a casing advantageously allows to protect the at least two light sources, the at least one photoreceiver and, where appropriate, the device for detecting the position of the backrest of the seat, but also to protect their positioning to maintain their orientations.

In particular exemplary embodiments of the invention, the casing is preferably disposed under a protective cover covering at least the upper portion of the backrest of the seat.

The invention also relates to an assembly including a seat, in accordance with at least one of its embodiments, and a Li-Fi device, external to said seat, the Li-Fi module being intended to communicate with the Li-Fi device and being positioned in an emission cone of said Li-Fi device.

The invention also relates to an aircraft cabin including a plurality of seats, in accordance with at least one of its embodiments, and a plurality of Li-Fi devices, each Li-Fi module communicating with a Li-Fi device, each Li-Fi device including a light source and a photoreceiver.

In particular embodiments of the invention, the Li-Fi devices are disposed in a ceiling of the cabin, at the luggage compartments.

### BRIEF DESCRIPTION OF THE FIGURES

The invention will be better understood upon reading the following description, given by way of non-limiting example, and made with reference to the following figures:

FIG. 1 illustrates an example of a data communication system using Li-Fi technology on board an aircraft;

FIG. 2 shows an enlargement of a headrest of an aircraft backrest of a seat including an example of a data communication module using Li-Fi technology according to the invention forming part of the data communication system according to the Li-Fi technology;

FIG. 3 shows a top view of an example of a data communication module using Li-Fi technology according to the invention.

In these figures, numerical references identical from one figure to another designate identical or similar elements. Moreover, for reasons of clarity, the drawings are not to scale, unless otherwise stated.

### DESCRIPTION OF EMBODIMENTS

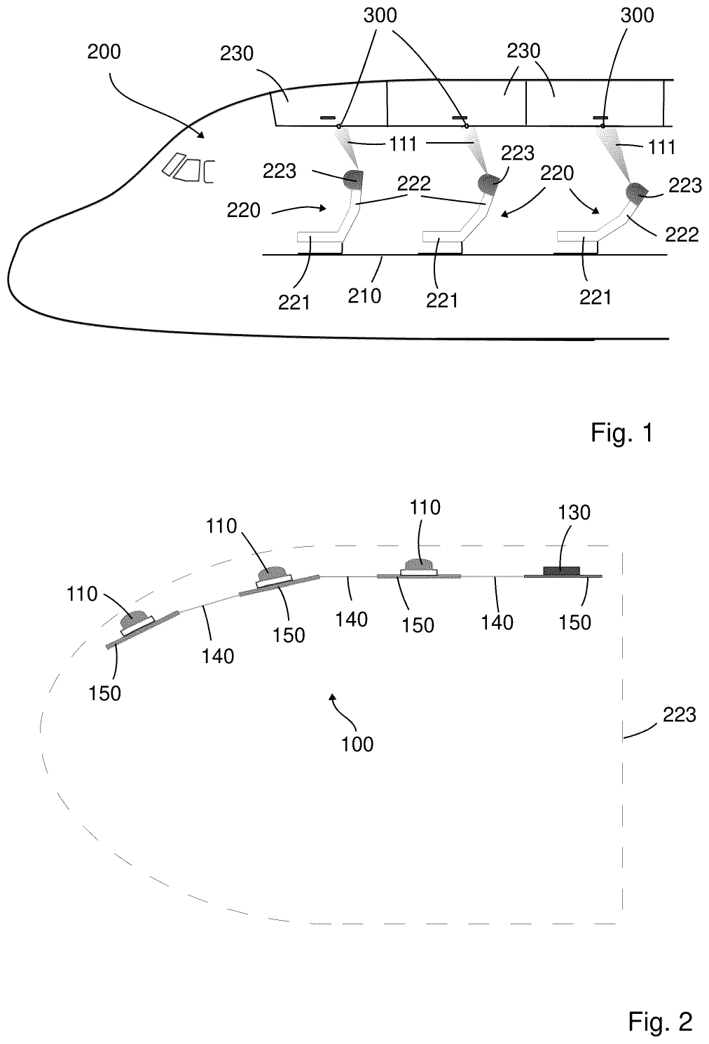

FIG. 1 schematically illustrates an aircraft cabin 200 wherein the invention can be deployed. The cabin 200 includes, in a conventional manner, a plurality of seats 220, in particular for receiving passengers.

Each seat 220 rests on a floor 210. Each seat 220 conventionally includes a seating surface 221 and a backrest 222. The backrest 222 has, at an upper portion, a headrest 223. The backrest 222 is preferably connected to the seating surface 221, for example by a joint allowing to adjust its inclination relative to the seating surface 221. The backrest 222 is preferably with adjustable inclination over a given inclination range. The backrest 222 is preferentially inclinable backwards relative to the seating surface 221, like those disposed for example in economy classes.

Each seat 220 has a median longitudinal plane.

In the example illustrated in FIG. 1, only three seats are shown. The backrest 222 of the seat 220 shown furthest to the left in FIG. 1 has zero inclination relative to the seating surface 221. The backrest 222 of the central seat in FIG. 1 has a first inclination relative to the seating surface 221 of the seat 220. The backrest 222 of the seat 220 shown furthest to the right in FIG. 1 has a second inclination relative to the seating surface 221 of the seat, greater than the first inclination.

The aircraft cabin 200 includes a data communication system using Li-Fi technology, called a Li-Fi communication system, adapted to communicate data coming from an aircraft network with equipment (not shown on the figures) either on board by the passengers, such as for example a tablet, a telephone or else a laptop, or present on board the plane, such as screens integrated into the seats of the plane.

The Li-Fi communication system advantageously allows each passenger to comprise secure access to entertainment data or internet data, regardless of the equipment used. The Li-Fi communication system allows to receive and/or send internal and/or external data to the aircraft in a secure and personalized manner in a predetermined physical location.

In a particular exemplary embodiment, the location may correspond to a space delimited to a seat, for a passenger. Thus, each passenger, when seated in their seat, benefits from a unique and personal connection space to receive and transmit data confidentially.

The Li-Fi communication system includes:
A plurality of data communication modules using Li-Fi technology, called Li-Fi modules 100,
A plurality of data communication devices using Li-Fi technology, called Li-Fi devices 300.

A Li-Fi module 100 is intended to equip a seat, preferably the backrest 222 of a seat 220. Each Li-Fi module 100 is preferably disposed at the upper portion of the backrest 222 of the associated seat 220, for example at the headrest 223 of the backrest 222.

Each seat 220 of the cabin 200 is thus preferably equipped with a Li-Fi module 100.

Each Li-Fi module 100 is intended to be connected to equipment.

Preferably, each Li-Fi module 100 is integrated into the seat 200 and is only connected to equipment (screen) integrated into the seat and/or to a USB (acronym for Universal Serial Bus) connector, so that the passenger can, using a charging cord, plug in his equipment (phone, tablet or laptop). It is obvious that any other type of connector can be used, for example a C type USB connector, an RJ 45 connector. The Li-Fi module 100 preferably forms part of the equipment which is integrated into the seat.

Each Li-Fi module 100 is intended to communicate with a Li-Fi device 300.

Each Li-Fi module 100 is advantageously positioned under an emission cone of the Li-Fi device 300 so that communication can be established between the Li-Fi device 300 and the Li-Fi module 100. The equipment, when connected to the Li-Fi module 100, is thus connected to the aircraft network via the Li-Fi module 100 and the Li-Fi device 300.

The Li-Fi devices 300 are, in turn, preferentially housed at a ceiling of the cabin 200.

In a preferred embodiment, the Li-Fi devices 300 are housed at the luggage compartments 230, for example one Li-Fi device 300 above each seat 220.

Li-Fi module 100

The description below describes in detail a Li-Fi module 100. This description applies by extension to all Li-Fi modules 100 in the cabin 200.

A Li-Fi module 100 includes:
at least two light sources 110, preferably a plurality of light sources 110,
at least one photoreceiver 120.

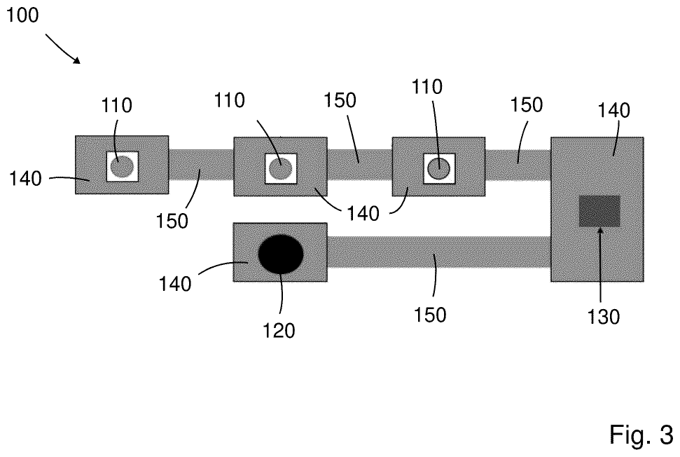

In the non-limiting example of FIGS. 2 and 3, the Li-Fi module 100 includes three light sources 110.

Each light source 110 is advantageously adapted to emit in the infrared range.

In an exemplary preferred embodiment, each light source 110 is a light-emitting diode (also known by the acronym LED) or a laser diode.

Each light source 110 is configured to emit a light beam, preferably in the form of an emission cone 111, with a predetermined maximum divergence angle. In the example of FIG. 1, the light beams shown, in the form of an emission cone 111, come from one of the light sources 110 of the Li-Fi module 100 of each seat 220.

The at least two light sources 110 of the Li-Fi module 100 are disposed at a distance from each other, in an aligned manner, as illustrated in FIG. 2.

When the Li-Fi module 100 is positioned on the backrest 222 of the seat 220, the at least two light sources 110 are aligned, preferably disposed parallel to the median longitudinal plane of the seat 220.

Each light source 110 of the Li-Fi module 100 is arranged on the backrest 222 of the seat 220 so as to be respectively associated with a sub-range of the inclination range of the backrest 222 of the seat 220. In other words, the inclination range is divided into at least two sub-ranges of inclination, preferably not overlapping. There are as many light sources 110 as there are sub-ranges.

The Li-Fi module 100 is positioned on the backrest 222 of the seat 220 so that, depending on the sub-range of inclination of the backrest 222 of the seat 220 in which the angle of inclination of the backrest 222 lies, the emitting beam of the light source 110 associated with this sub-range is configured to be directed onto the associated Li-Fi device 300.

In other words, each light source 110 of the Li-Fi module 100 is positioned on the backrest 222 of the seat 220, so that, depending on the sub-range of inclination of the backrest 222 of the seat 220 in which the angle of inclination of the backrest 222 lies, the Li-Fi device 300 is in the emission cone 111 of the light source 110 associated with this sub-range.

Angle of inclination means the angle of inclination of the backrest 222 relative to the seating surface 221 of the seat 220. The backrest 222 has a zero angle of inclination when the backrest 222 is perpendicular to the seating surface 221.

In a non-limiting exemplary embodiment, as illustrated in FIGS. 1 to 3, the module includes three light sources 110, each light source 110 corresponding to a sub-range of inclination of the backrest 222. The inclination range of the backrest 222 of the seat 220 is thus broken down into three sub-ranges.

For example, when the inclination range of the backrest 222 is comprised between [0°-30°] and the module includes three light sources 110, the inclination range of the backrest 222 of the seat 220 is broken down into three sub-ranges: [0-10], [10-20], [20-30].

It is possible to increase the number of light sources 110, and therefore the number of associated sub-ranges.

The at least one photoreceiver 120 of the Li-Fi module 100 is positioned on the seat 220 so that, regardless of the angle of inclination of the backrest 222 of the seat, in the inclination range of said backrest 222, the at least one photoreceiver 120 is always in the emission cone of the Li-Fi device 300.

In an exemplary embodiment, the at least one photoreceiver 120 is a photodiode.

In one embodiment, the at least one photoreceiver 120 can be positioned on the seat 220 in continuity with the positioning of the light sources 110, or between two light sources 110.

In a preferred embodiment, the at least one photoreceiver 120 of the Li-Fi module 100 is positioned on the seat, parallel to the light sources 110.

In an exemplary embodiment, as illustrated in FIG. 3, the Li-Fi module 100 includes a single photoreceiver 120. When the Li-Fi module 100 includes three light sources 110, as illustrated in FIG. 3, the photoreceiver 120 is preferably disposed at the central light source 110.

In another exemplary embodiment, the Li-Fi module 100 may include as many photoreceivers 120 as light sources 110. In this example, when the Li-Fi module 100 is positioned on the backrest 222 of the seat, the photoreceivers 120 are aligned, preferably disposed parallel to the light sources 110 and parallel to the median longitudinal plane of the seat 220.

The Li-Fi module 100 includes a controller configured in particular to control each light source 110 of the Li-Fi module 100.

In a first configuration of use of the Li-Fi module 100, all the light sources 110 of the Li-Fi module 100 are active at the same time.

In a second configuration of use of the Li-Fi module 100, only one light source 110 of the Li-Fi module 100 is active at a time. The controller is advantageously configured to control the light sources 110 according to the angle of inclination of the backrest 222 of the seat 220. The controller is configured so that, depending on the angle of inclination of the backrest 222, only the light source 110 associated with the sub-range of inclination of the backrest 222 of the seat 220 in which the angle of inclination of the backrest 222 lies is activated. The other light sources 110 of the Li-Fi module 100 are inactive and/or deactivated.

In this second configuration, to determine the angle of inclination of the backrest 222 of the seat, the Li-Fi module 100 includes a device 130 for detecting the position of the backrest 222 of the seat 220.

In an exemplary embodiment, the device 130 for detecting the position of the backrest 222 of the seat 220 includes a position sensor, such as an inclinometer, disposed on the backrest 222 of the seat 220.

In another exemplary embodiment, the device 130 for detecting the position of the backrest 222 of the seat 220 includes a position sensor disposed on the backrest 222 of the seat 220 and a position sensor disposed on the seating surface 221 of the seat 220 or at the floor 210. The two position sensors are for example inclinometers. In this exemplary embodiment, the controller preferably includes a calculator configured to determine, by difference, the angle of inclination of the backrest 222 relative to the seating surface 221. In such an exemplary embodiment, the position sensor disposed on the seating surface 221 of the seat 220 or at the floor 210 serves as a reference to guarantee that it is indeed the inclination of the backrest 222 and not the inclination of the aircraft.

In another exemplary embodiment, the device 130 for detecting the position of the backrest 222 of the seat 220 includes a distance sensor disposed on the backrest 222 of the seat 220 configured to measure the distance between the backrest 222 and a reference point on the ceiling of the cabin 200. In this exemplary embodiment, the controller of the Li-Fi module 100 preferably includes a calculator configured to deduce the angle of inclination of the backrest 222 relative to the seating surface 221 from the measurement of the distance by the distance sensor. In one embodiment, the distance sensor is a “TOF” (acronym for Time Of Flight) distance sensor.

The electronic components of the Li-Fi module 100, that is to say the at least two light sources 110, the at least one photoreceiver 120, the controller, and where appropriate all or part of the device 130 for detecting the position of the backrest 222 of the seat, are preferably soldered on a rigid printed circuit board (or PCB) 140. The components constituting the controller are also preferentially soldered on the rigid printed circuit board 140.

In a non-limiting embodiment, each light source 110, the at least one photoreceiver 120, the controller, and where appropriate and all or part of the device 130 for detecting the position of the backrest 222 of the seat, are respectively each soldered on a rigid printed circuit board 140. Two rigid printed circuit boards 140 are connected together by a flexible printed circuit board 150. Thus, better heat dissipation of each component is obtained. In addition, due to the flexibility of the flexible printed circuit boards 150, it is possible to be adapted to the curvature of the headrest 223.

In an exemplary embodiment, as illustrated in FIG. 3, the rigid printed circuit boards of each light source 110 are interconnected by a flexible printed circuit board 150 and form a line and are connected to the electronic circuit including the components constituting the controller, and where appropriate all or part of the device 130 for detecting the position of the backrest 222 of the seat 220. The rigid printed circuit board 140 of the photoreceiver 120 is also connected to the electronic circuit including the components constituting the controller, and where appropriate all or part of the device 130 for detecting the position of the backrest 222 of the seat 220.

In a particular embodiment, to protect the electronic components of the Li-Fi module 100, said Li-Fi module may include a casing (not shown in the figures) wherein the light sources 110 are integrated, the at least one photoreceiver 120, the controller and, where appropriate, the device 130 for detecting the position of the backrest 222 of the seat 220.

Preferably, the casing is made of a material allowing the transmission of infrared wavelengths.

The casing is preferably disposed under the protective cover covering the backrest 222 of the seat 220 and the headrest 223.

The casing is preferably disposed on one side of the headrest 223 of the backrest 222, so that the head of the passenger seated on the seat 220 does not disturb the transmission of the light beams of the light sources 110.

As previously described, a Li-Fi module 100 is configured to communicate with a Li-Fi device 300.

As an assembly, mention will be made of a seat 220, with its Li-Fi module 100, and a Li-Fi device 300, external to said seat. The Li-Fi module 100 is positioned in the emission cone of said Li-Fi device.

A Li-Fi device 300 preferably includes a light source and a photoreceiver (not shown in the figures). The emission cone of the Li-Fi device 300 previously mentioned in the description corresponds to the emission cone of the light source of the Li-Fi device 300.

A data transmission/reception unit is configured to manage the light source and the photoreceiver of the Li-Fi device 300.

In one embodiment, each Li-Fi device 300 includes a data transmission/reception unit.

Alternatively, a single data transmission/reception unit can manage the light source and the photoreceiver of all Li-Fi devices 300 of the cabin 200.

In a preferred exemplary embodiment, the light source of a Li-Fi device 300 is a light-emitting diode or a laser diode.

In a preferred embodiment, the photoreceiver of a Li-Fi device 300 is a photodiode.

In one embodiment, the light source and the photoreceiver of a Li-Fi device 300 are disposed at the ceiling of the cabin 200, for example at the luggage compartments 230, preferably near the lighting spots.

In a variant embodiment, the light source and the photoreceiver of a Li-Fi device 300 are remoted to another portion of the aircraft and an optical fibre routes the optical signals to an optical interface disposed at a ceiling of the cabin 200, for example at the luggage compartments 230, preferably near the lighting spots.

In operation, the Li-Fi communication system allows to establish bidirectional data communication between the aircraft network and equipment located in a privileged space related to a seat 220.

The data transmission/reception unit is configured to convert a digital signal, carrying the data information to be transmitted, into a modulated optical signal. The modulated optical signal is of Li-Fi type.

In the downward direction of communication, that is to say in the direction of data transmission from the aircraft network to equipment in a privileged space related to a seat, the light source of a Li-Fi device 300 receives an instruction from the data transmission/reception unit and is controlled for the emission of a modulated optical signal, called the first modulated optical signal.

In a non-limiting exemplary embodiment, this modulation of the optical signal is obtained by controlling the intensity of the light source of said Li-Fi device 300 variably at very high frequency.

The first modulated optical signal is confined in a restricted emission cone of said Li-Fi device 300 defining the volume of the privileged space related to the seat 220.

At least one photoreceiver 120 of the Li-Fi module 100 of the seat 220 is configured to detect the first modulated optical signal emitted by the light source of the Li-Fi device 300. The at least one photoreceiver 120 of the Li-Fi module 100 will convert the first modulated optical signal into a digital signal. This digital signal is then processed by the controller of the Li-Fi module 100, translated into information usable by the equipment and transmitted to said equipment.

### Case where the Controller Activates Only One of the Light Sources Depending on the Inclination of the Seat

In the upward direction of communication, that is to say in the direction of transmission of data from equipment to the aircraft network, said equipment transmits data to the controller of the Li-Fi module 100 associated with the seat 220. Depending on the inclination of the seat, only the light source 110 of the Li-Fi module 100 associated with the sub-range of inclination of the backrest 222 of the seat 220 wherein the angle of backrest inclination 222 receives an instruction from the controller and is controlled for the emission of a modulated optical signal, called a second modulated optical signal. The second modulated optical signal is confined in the restricted emission cone 111 of said light source of the Li-Fi module 100. The photoreceiver of the Li-Fi device 300, or the optical interface, depending on the alternative embodiment of the Li-Fi device 300, is located in the emission cone 111 of the light source 110 of the Li-Fi module 100.

The photoreceiver of the Li-Fi device 300 is configured to detect the second modulated optical signal emitted by said light source 110 of the Li-Fi module 100. The photoreceiver of the Li-Fi device 300 will convert the second modulated optical signal into a digital signal. This digital signal is then processed by the data transmission/reception unit of the Li-Fi device 300, translated into information usable by the aircraft network and transmitted to the aircraft network.

Thus, thanks to such a Li-Fi module 100, regardless of the angle of inclination of the backrest 222 of the seat, it is possible to maintain the optimal performance of the Li-Fi communication system, by guaranteeing the flow rate, even when the seats have an inclinable 222 backrest.

The invention allows to use a Li-Fi module 100 including light sources 110 whose maximum angle of divergence of the light beam (maximum angle of divergence of the emission cone) can be optimised, and therefore restricted.

Thus, the electrical consumption of the light sources 110 of the Li-Fi module 100, and consequently their thermal heating, is limited.

In addition, thanks to the use of flexible electronic circuits and rigid electronic circuits for the production of a Li-Fi module 100, the positioning of the latter at the headrest 223 of the backrest 222 of the seat 220 is made easier.

1-8. (canceled)

9. A seat comprising a backrest adjustable in inclination, with an angle of inclination comprised within a predefined inclination range, the seat comprising a data communication module using a light fidelity (Li-Fi) technology, referred to as a Li-Fi module, positioned at an upper portion of the backrest, the Li-Fi module being configured to communicate with an associated data communication device using the Li-Fi technology, referred to as a Li-Fi device, wherein the Li-Fi module comprises:
at least two light sources, each light source being configured to emit an emitting beam; and a
at least one photoreceiver:
said at least two light sources being aligned, disposed parallel to a median longitudinal plane of the seat, said each light source being arranged on the backrest of the seat so as to be respectively associated with a sub-range of the predefined inclination range of the backrest of said seat; and
wherein a light source associated with the sub-range in which the angle of inclination of the backrest lies is active.

10. The seat of claim 9, wherein the Li-Fi module further comprises:
a sensor to detect a position of the backrest of the seat and to determine the angle of inclination of the backrest of the seat; and
a controller configured to control said at least two light sources according to the angle of inclination of the backrest of the seat.

11. The seat of claim 10, wherein the controller is configured to activate the light source associated with the sub-range in which the angle of inclination of the backrest lies.

12. The seat of claim of claim 10, wherein the sensor is an inclinometer or a time-of-flight distance sensor.

13. The seat of claim 9, wherein said each light source is soldered on a rigid printed circuit board and a flexible printed circuit board connects the rigid printed circuit boards together.

14. The seat of claim 9, wherein the Li-Fi module further comprises a casing to protect said at least two light sources and said at least one photoreceiver.

15. An assembly comprising the seat of claim 9 and the Li-Fi device external to the seat, the Li-Fi module being positioned in an emission cone of the Li-Fi device.

16. An aircraft cabin comprising a plurality of seats of claim 9, and a plurality of Li-Fi devices, each Li-Fi module communicating with a corresponding Li-Fi device, each Li-Fi device comprising a light source and a photoreceiver.
